(19) United States
(12) Patent Application Publication
(10) Pub. No.: US 2025/0209145 A1
(43) Pub. Date: Jun. 26, 2025

(54) WEARABLE DEVICE CHARGER WITH FINGERPRINT READER

(71) Applicant: Oura Health Oy, Oulu (FI)

(72) Inventor: Jukka Tapani Mäkinen, Oulu (FI)

(21) Appl. No.: 18/390,312

(22) Filed: Dec. 20, 2023

(51) Int. Cl. G06F 21/32; G06F 1/16; G06V 40/12; G06V 40/13; G06V 40/50; H02J 7/00

(52) U.S. Cl. CPC G06F 21/32; G06V 40/1306; G06V 40/1318; G06V 40/1365; G06V 40/50; H02J 7/00045; H02J 7/0044; G06F 1/163

(57) ABSTRACT

Methods, systems, and devices for a wearable ring device charger that features a fingerprint scanner to increase security of the sensitive data are described. For example, the wearable ring device may store sensitive health data or other sensitive data. A user may protect the sensitive data by preventing the data from being uploaded (e.g., from the wearable ring device to the charger or to the smart device application) until a fingerprint scan is performed. A fingerprint scanner of the charger may include one or more of a capacitance reader, an optical sensor (e.g., a camera), or an ultrasonic sensor to sense data associated with the fingerprint of the user. In some examples, the wearable ring device may store fingerprint data associated with the user to allow the user to scan the wearable ring device in lieu of scanning a physical fingerprint.

### FIELD OF TECHNOLOGY

The following relates to wearable devices and data processing, including a wearable device charger with a fingerprint reader.

### BACKGROUND

Some wearable devices may be configured to store data, such as health data collected from users of the wearable devices. In some examples, a connection between the wearable devices and external devices may not be secure, which may allow unauthorized users to access the stored data.

### BRIEF DESCRIPTION OF THE DRAWINGS

FIG. 1 illustrates an example of a system that supports a wearable device charger with a fingerprint reader in accordance with aspects of the present disclosure.

FIG. 2 illustrates an example of a system that supports a wearable device charger with a fingerprint reader in accordance with aspects of the present disclosure.

FIG. 3 shows an example of a system that supports a wearable device charger with a fingerprint reader in accordance with aspects of the present disclosure.

FIG. 4 shows an example of a charger diagram that supports a wearable device charger with a fingerprint reader in accordance with aspects of the present disclosure.

### DETAILED DESCRIPTION

Wearable devices may be used to collect and store sensitive physiological data of a user, such as heart rate data, temperature data, respiratory rate data, illness data, and the like. In some cases, wearable devices may be associated with an application (“App”) that is executable on a smart device (e.g., a smartphone), where the app is used to view data collected via the wearable device. Many users have a desire to keep such sensitive physiological data private and secure. However, wearable devices often communicate data to the app via Bluetooth and other wireless connections, which may not be secure. That is, unauthorized users (e.g., bad actors) may leverage Bluetooth connections between wearable devices and corresponding user devices to gain access to private, sensitive data. Moreover, when exchanging data from a wearable device to an app or other user device, there is often no way to verify that the transferred data is associated with the respective user.

Accordingly, aspects of the present disclosure are directed to a charger device for wearable devices that includes a fingerprint scanner to increase security of sensitive data collected via the wearable devices. A fingerprint scanner on a charger device may be used to authenticate an identity of a user associated with the wearable device, and thereby authorize data to be transferred from the wearable device to the charger and/or a user device (e.g., app). For example, the user may protect sensitive data collected via a wearable device by requiring a fingerprint scan prior to uploading the sensitive data from the wearable device to the charger, or from the wearable device to the smart device application. The fingerprint scanner may include one or more of a capacitance reader, an optical sensor (e.g., a camera), or an ultrasonic sensor. In some examples, the fingerprint scanner may be used to generate a “fingerprint token” (e.g., digital version of the user's fingerprint) that may be stored at the wearable device, where the wearable device may output the stored fingerprint token to authenticate the user in lieu of scanning a physical fingerprint (e.g., instead of the user scanning their fingerprint to access a building, the user can tap a fingerprint scanner with a wearable device to output the fingerprint token).

Aspects of the disclosure are initially described in the context of systems supporting physiological data collection from users via wearable devices. Aspects of the disclosure are further illustrated by and described with reference to charging device diagrams.

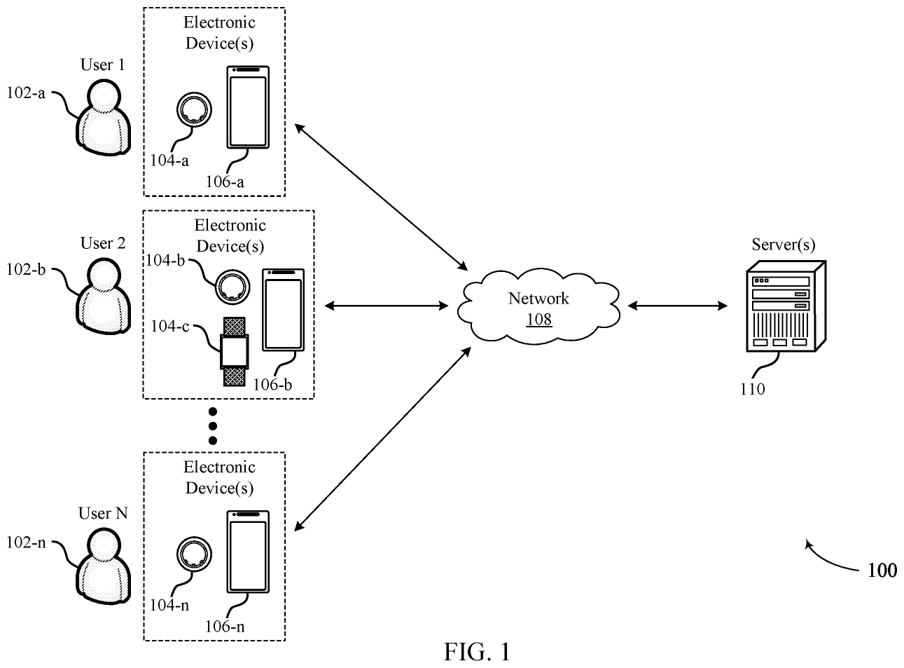

FIG. 1 illustrates an example of a system 100 that supports a wearable device charger with a fingerprint reader in accordance with aspects of the present disclosure. The system 100 includes a plurality of electronic devices (e.g., wearable devices 104, user devices 106) that may be worn and/or operated by one or more users 102. The system 100 further includes a network 108 and one or more servers 110.

The electronic devices may include any electronic devices known in the art, including wearable devices 104 (e.g., ring wearable devices, watch wearable devices, etc.), user devices 106 (e.g., smartphones, laptops, tablets). The electronic devices associated with the respective users 102 may include one or more of the following functionalities: 1) measuring physiological data, 2) storing the measured data, 3) processing the data, 4) providing outputs (e.g., via GUIs) to a user 102 based on the processed data, and 5) communicating data with one another and/or other computing devices. Different electronic devices may perform one or more of the functionalities.

Example wearable devices 104 may include wearable computing devices, such as a ring computing device (hereinafter “ring”) configured to be worn on a user's 102 finger, a wrist computing device (e.g., a smart watch, fitness band, or bracelet) configured to be worn on a user's 102 wrist, and/or a head mounted computing device (e.g., glasses/goggles). Wearable devices 104 may also include bands, straps (e.g., flexible or inflexible bands or straps), stick-on sensors, and the like, that may be positioned in other locations, such as bands around the head (e.g., a forehead headband), arm (e.g., a forearm band and/or bicep band), and/or leg (e.g., a thigh or calf band), behind the ear, under the armpit, and the like. Wearable devices 104 may also be attached to, or included in, articles of clothing. For example, wearable devices 104 may be included in pockets and/or pouches on clothing. As another example, wearable device 104 may be clipped and/or pinned to clothing, or may otherwise be maintained within the vicinity of the user 102. Example articles of clothing may include, but are not limited to, hats, shirts, gloves, pants, socks, outerwear (e.g., jackets), and undergarments. In some implementations, wearable devices 104 may be included with other types of devices such as training/sporting devices that are used during physical activity. For example, wearable devices 104 may be attached to, or included in, a bicycle, skis, a tennis racket, a golf club, and/or training weights.

Much of the present disclosure may be described in the context of a ring wearable device 104. Accordingly, the terms “ring 104,” “wearable device 104,” and like terms, may be used interchangeably, unless noted otherwise herein. However, the use of the term “ring 104” is not to be regarded as limiting, as it is contemplated herein that aspects of the present disclosure may be performed using other wearable devices (e.g., watch wearable devices, necklace wearable device, bracelet wearable devices, earring wearable devices, anklet wearable devices, and the like).

In some aspects, user devices 106 may include handheld mobile computing devices, such as smartphones and tablet computing devices. User devices 106 may also include personal computers, such as laptop and desktop computing devices. Other example user devices 106 may include server computing devices that may communicate with other electronic devices (e.g., via the Internet). In some implementations, computing devices may include medical devices, such as external wearable computing devices (e.g., Holter monitors). Medical devices may also include implantable medical devices, such as pacemakers and cardioverter defibrillators. Other example user devices 106 may include home computing devices, such as internet of things (IoT) devices (e.g., IoT devices), smart televisions, smart speakers, smart displays (e.g., video call displays), hubs (e.g., wireless communication hubs), security systems, smart appliances (e.g., thermostats and refrigerators), and fitness equipment.

Some electronic devices (e.g., wearable devices 104, user devices 106) may measure physiological parameters of respective users 102, such as photoplethysmography waveforms, continuous skin temperature, a pulse waveform, respiration rate, heart rate, heart rate variability (HRV), actigraphy, galvanic skin response, pulse oximetry, blood oxygen saturation (SpO2), blood sugar levels (e.g., glucose metrics), and/or other physiological parameters. Some electronic devices that measure physiological parameters may also perform some/all of the calculations described herein. Some electronic devices may not measure physiological parameters, but may perform some/all of the calculations described herein. For example, a ring (e.g., wearable device 104), mobile device application, or a server computing device may process received physiological data that was measured by other devices.

In some implementations, a user 102 may operate, or may be associated with, multiple electronic devices, some of which may measure physiological parameters and some of which may process the measured physiological parameters. In some implementations, a user 102 may have a ring (e.g., wearable device 104) that measures physiological parameters. The user 102 may also have, or be associated with, a user device 106 (e.g., mobile device, smartphone), where the wearable device 104 and the user device 106 are communicatively coupled to one another. In some cases, the user device 106 may receive data from the wearable device 104 and perform some/all of the calculations described herein. In some implementations, the user device 106 may also measure physiological parameters described herein, such as motion/activity parameters.

For example, as illustrated in FIG. 1, a first user 102-a (User 1) may operate, or may be associated with, a wearable device 104-a (e.g., ring 104-a) and a user device 106-a that may operate as described herein. In this example, the user device 106-a associated with user 102-a may process/store physiological parameters measured by the ring 104-a. Comparatively, a second user 102-b (User 2) may be associated with a ring 104-b, a watch wearable device 104-c (e.g., watch 104-c), and a user device 106-b, where the user device 106-b associated with user 102-b may process/store physiological parameters measured by the ring 104-b and/or the watch 104-c. Moreover, an nth user 102-n (User N) may be associated with an arrangement of electronic devices described herein (e.g., ring 104-n, user device 106-n). In some aspects, wearable devices 104 (e.g., rings 104, watches 104) and other electronic devices may be communicatively coupled to the user devices 106 of the respective users 102 via Bluetooth, Wi-Fi, infrared, and other wireless protocols. Moreover, in some cases, the wearable device 104 and the user device 106 may be included within (or make up) the same device. For example, in some cases, the wearable device 104 may be configured to execute an application associated with the wearable device 104, and may be configured to display data via a GUI.

In some implementations, the rings 104 (e.g., wearable devices 104) of the system 100 may be configured to collect physiological data from the respective users 102 based on arterial blood flow within the user's finger. In particular, a ring 104 may utilize one or more light-emitting components, such as LEDs (e.g., red LEDs, green LEDs) that emit light on the palm-side of a user's finger to collect physiological data based on arterial blood flow within the user's finger. In general, the terms light-emitting components, light-emitting elements, and like terms, may include, but are not limited to, LEDs, micro LEDs, mini LEDs, laser diodes (LDs) (e.g., vertical cavity surface-emitting lasers (VCSELs), and the like.

In some cases, the system 100 may be configured to collect physiological data from the respective users 102 based on blood flow diffused into a microvascular bed of skin with capillaries and arterioles. For example, the system 100 may collect PPG data based on a measured amount of blood diffused into the microvascular system of capillaries and arterioles. In some implementations, the ring 104 may acquire the physiological data using a combination of both green and red LEDs. The physiological data may include any physiological data known in the art including, but not limited to, temperature data, accelerometer data (e.g., movement/motion data), heart rate data, HRV data, blood oxygen level data, or any combination thereof.

The use of both green and red LEDs may provide several advantages over other solutions, as red and green LEDs have been found to have their own distinct advantages when acquiring physiological data under different conditions (e.g., light/dark, active/inactive) and via different parts of the body, and the like. For example, green LEDs have been found to exhibit better performance during exercise. Moreover, using multiple LEDs (e.g., green and red LEDs) distributed around the ring 104 has been found to exhibit superior performance as compared to wearable devices that utilize LEDs that are positioned close to one another, such as within a watch wearable device. Furthermore, the blood vessels in the finger (e.g., arteries, capillaries) are more accessible via LEDs as compared to blood vessels in the wrist. In particular, arteries in the wrist are positioned on the bottom of the wrist (e.g., palm-side of the wrist), meaning only capillaries are accessible on the top of the wrist (e.g., back of hand side of the wrist), where wearable watch devices and similar devices are typically worn. As such, utilizing LEDs and other sensors within a ring 104 has been found to exhibit superior performance as compared to wearable devices worn on the wrist, as the ring 104 may have greater access to arteries (as compared to capillaries), thereby resulting in stronger signals and more valuable physiological data.

The electronic devices of the system 100 (e.g., user devices 106, wearable devices 104) may be communicatively coupled to one or more servers 110 via wired or wireless communication protocols. For example, as shown in FIG. 1, the electronic devices (e.g., user devices 106) may be communicatively coupled to one or more servers 110 via a network 108. The network 108 may implement transfer control protocol and internet protocol (TCP/IP), such as the Internet, or may implement other network 108 protocols. Network connections between the network 108 and the respective electronic devices may facilitate transport of data via email, web, text messages, mail, or any other appropriate form of interaction within a computer network 108. For example, in some implementations, the ring 104-a associated with the first user 102-a may be communicatively coupled to the user device 106-a, where the user device 106-a is communicatively coupled to the servers 110 via the network 108. In additional or alternative cases, wearable devices 104 (e.g., rings 104, watches 104) may be directly communicatively coupled to the network 108.

The system 100 may offer an on-demand database service between the user devices 106 and the one or more servers 110. In some cases, the servers 110 may receive data from the user devices 106 via the network 108, and may store and analyze the data. Similarly, the servers 110 may provide data to the user devices 106 via the network 108. In some cases, the servers 110 may be located at one or more data centers. The servers 110 may be used for data storage, management, and processing. In some implementations, the servers 110 may provide a web-based interface to the user device 106 via web browsers.

In some aspects, the system 100 may detect periods of time that a user 102 is asleep, and classify periods of time that the user 102 is asleep into one or more sleep stages (e.g., sleep stage classification). For example, as shown in FIG. 1, User 102-a may be associated with a wearable device 104-a (e.g., ring 104-a) and a user device 106-a. In this example, the ring 104-a may collect physiological data associated with the user 102-a, including temperature, heart rate, HRV, respiratory rate, and the like. In some aspects, data collected by the ring 104-a may be input to a machine learning classifier, where the machine learning classifier is configured to determine periods of time that the user 102-a is (or was) asleep. Moreover, the machine learning classifier may be configured to classify periods of time into different sleep stages, including an awake sleep stage, a rapid eye movement (REM) sleep stage, a light sleep stage (non-REM (NREM)), and a deep sleep stage (NREM). In some aspects, the classified sleep stages may be displayed to the user 102-a via a GUI of the user device 106-a. Sleep stage classification may be used to provide feedback to a user 102-a regarding the user's sleeping patterns, such as recommended bedtimes, recommended wake-up times, and the like. Moreover, in some implementations, sleep stage classification techniques described herein may be used to calculate scores for the respective user, such as Sleep Scores, Readiness Scores, and the like.

In some aspects, the system 100 may utilize circadian rhythm-derived features to further improve physiological data collection, data processing procedures, and other techniques described herein. The term circadian rhythm may refer to a natural, internal process that regulates an individual's sleep-wake cycle, that repeats approximately every 24 hours. In this regard, techniques described herein may utilize circadian rhythm adjustment models to improve physiological data collection, analysis, and data processing. For example, a circadian rhythm adjustment model may be input into a machine learning classifier along with physiological data collected from the user 102-a via the wearable device 104-a. In this example, the circadian rhythm adjustment model may be configured to “weight,” or adjust, physiological data collected throughout a user's natural, approximately 24-hour circadian rhythm. In some implementations, the system may initially start with a “baseline” circadian rhythm adjustment model, and may modify the baseline model using physiological data collected from each user 102 to generate tailored, individualized circadian rhythm adjustment models that are specific to each respective user 102.

In some aspects, the system 100 may utilize other biological rhythms to further improve physiological data collection, analysis, and processing by phase of these other rhythms. For example, if a weekly rhythm is detected within an individual's baseline data, then the model may be configured to adjust “weights” of data by day of the week. Biological rhythms that may require adjustment to the model by this method include: 1) ultradian (faster than a day rhythms, including sleep cycles in a sleep state, and oscillations from less than an hour to several hours periodicity in the measured physiological variables during wake state; 2) circadian rhythms; 3) non-endogenous daily rhythms shown to be imposed on top of circadian rhythms, as in work schedules; 4) weekly rhythms, or other artificial time periodicities exogenously imposed (e.g. in a hypothetical culture with 12 day “weeks,” 12 day rhythms could be used); 5) multi-day ovarian rhythms in women and spermatogenesis rhythms in men; 6) lunar rhythms (relevant for individuals living with low or no artificial lights); and 7) seasonal rhythms.

The biological rhythms are not always stationary rhythms. For example, many women experience variability in ovarian cycle length across cycles, and ultradian rhythms are not expected to occur at exactly the same time or periodicity across days even within a user. As such, signal processing techniques sufficient to quantify the frequency composition while preserving temporal resolution of these rhythms in physiological data may be used to improve detection of these rhythms, to assign phase of each rhythm to each moment in time measured, and to thereby modify adjustment models and comparisons of time intervals. The biological rhythm-adjustment models and parameters can be added in linear or non-linear combinations as appropriate to more accurately capture the dynamic physiological baselines of an individual or group of individuals.

In some examples, the devices of the system 100 may receive and store data other than physiological or health data associated with a user. For example, the user may upload NFC data to a wireless ring device 104 (e.g., via an application of a smart device 106) that may be used to perform one or more operations with external devices (e.g., devices outside of the system 100). The user may accordingly use the wireless ring device 104 to transmit the NFC data to the external devices to perform the one or more operations. For example, the user may use the NFC data stored on the wireless ring device 104 to lock or unlock one or more doors, activate one or more automated home management procedures such as adjusting light and temperature systems, and the like.

In some aspects, the respective devices of the system 100 may support techniques for a charger for a wearable ring device 104 to perform a fingerprint scan to increase security of sensitive data (e.g., physiological data, NFC data) stored by the wearable ring device 104. For example, a user may protect the sensitive data by preventing the data from being uploaded (e.g., from the wearable ring device 104 to an external device such as the charger or a smart device 106) until a fingerprint scan is performed. A fingerprint scanner of the charger may include one or more of a capacitance reader, an optical sensor (e.g., a camera), or an ultrasonic sensor to sense data associated with the fingerprint of the user. In some examples, the wearable ring device 104 may store fingerprint data associated with the user to allow the user to scan the wearable ring device 104 in lieu of scanning a physical fingerprint.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

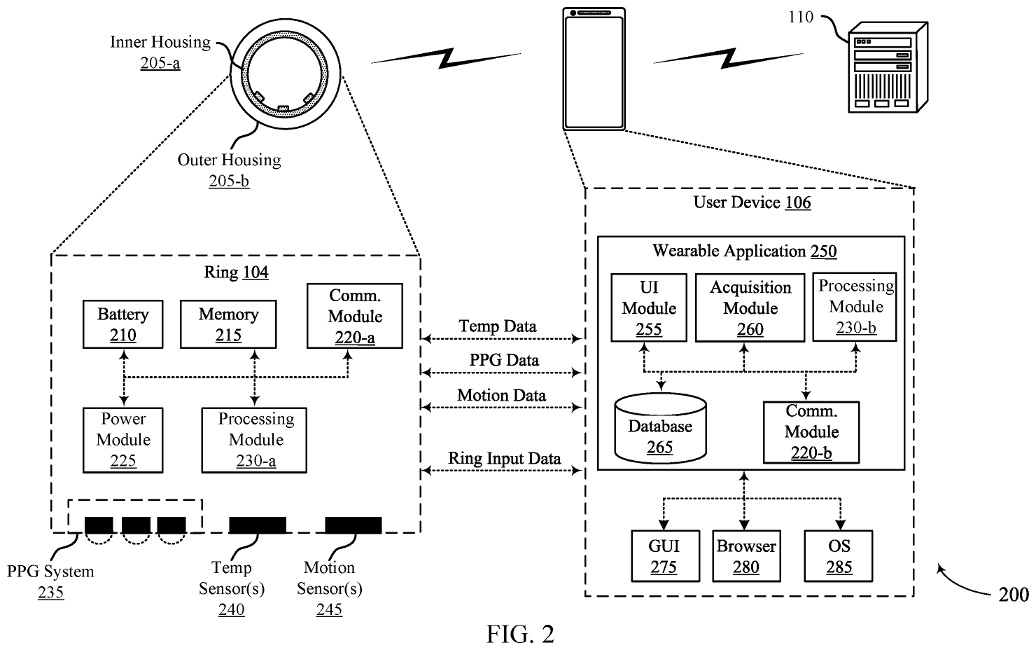

FIG. 2 illustrates an example of a system 200 that supports a wearable device charger with a fingerprint reader in accordance with aspects of the present disclosure. The system 200 may implement, or be implemented by, system 100. In particular, system 200 illustrates an example of a ring 104 (e.g., wearable device 104), a user device 106, and a server 110, as described with reference to FIG. 1.

In some aspects, the ring 104 may be configured to be worn around a user's finger, and may determine one or more user physiological parameters when worn around the user's finger. Example measurements and determinations may include, but are not limited to, user skin temperature, pulse waveforms, respiratory rate, heart rate, HRV, blood oxygen levels (SpO2), blood sugar levels (e.g., glucose metrics), and the like.

The system 200 further includes a user device 106 (e.g., a smartphone) in communication with the ring 104. For example, the ring 104 may be in wireless and/or wired communication with the user device 106. In some implementations, the ring 104 may send measured and processed data (e.g., temperature data, photoplethysmogram (PPG) data, motion/accelerometer data, ring input data, and the like) to the user device 106. The user device 106 may also send data to the ring 104, such as ring 104 firmware/configuration updates. The user device 106 may process data. In some implementations, the user device 106 may transmit data to the server 110 for processing and/or storage.

The ring 104 may include a housing 205 that may include an inner housing 205-a and an outer housing 205-b. In some aspects, the housing 205 of the ring 104 may store or otherwise include various components of the ring including, but not limited to, device electronics, a power source (e.g., battery 210, and/or capacitor), one or more substrates (e.g., printable circuit boards) that interconnect the device electronics and/or power source, and the like. The device electronics may include device modules (e.g., hardware/software), such as: a processing module 230-a, a memory 215, a communication module 220-a, a power module 225, and the like. The device electronics may also include one or more sensors. Example sensors may include one or more temperature sensors 240, a PPG sensor assembly (e.g., PPG system 235), and one or more motion sensors 245.

The sensors may include associated modules (not illustrated) configured to communicate with the respective components/modules of the ring 104, and generate signals associated with the respective sensors. In some aspects, each of the components/modules of the ring 104 may be communicatively coupled to one another via wired or wireless connections. Moreover, the ring 104 may include additional and/or alternative sensors or other components that are configured to collect physiological data from the user, including light sensors (e.g., LEDs), oximeters, and the like.

The ring 104 shown and described with reference to FIG. 2 is provided solely for illustrative purposes. As such, the ring 104 may include additional or alternative components as those illustrated in FIG. 2. Other rings 104 that provide functionality described herein may be fabricated. For example, rings 104 with fewer components (e.g., sensors) may be fabricated. In a specific example, a ring 104 with a single temperature sensor 240 (or other sensor), a power source, and device electronics configured to read the single temperature sensor 240 (or other sensor) may be fabricated. In another specific example, a temperature sensor 240 (or other sensor) may be attached to a user's finger (e.g., using adhesives, wraps, clamps, spring loaded clamps, etc.). In this case, the sensor may be wired to another computing device, such as a wrist worn computing device that reads the temperature sensor 240 (or other sensor). In other examples, a ring 104 that includes additional sensors and processing functionality may be fabricated.

The housing 205 may include one or more housing 205 components. The housing 205 may include an outer housing 205-b component (e.g., a shell) and an inner housing 205-a component (e.g., a molding). The housing 205 may include additional components (e.g., additional layers) not explicitly illustrated in FIG. 2. For example, in some implementations, the ring 104 may include one or more insulating layers that electrically insulate the device electronics and other conductive materials (e.g., electrical traces) from the outer housing 205-b (e.g., a metal outer housing 205-b). The housing 205 may provide structural support for the device electronics, battery 210, substrate(s), and other components. For example, the housing 205 may protect the device electronics, battery 210, and substrate(s) from mechanical forces, such as pressure and impacts. The housing 205 may also protect the device electronics, battery 210, and substrate(s) from water and/or other chemicals.

The outer housing 205-b may be fabricated from one or more materials. In some implementations, the outer housing 205-b may include a metal, such as titanium, that may provide strength and abrasion resistance at a relatively light weight. The outer housing 205-b may also be fabricated from other materials, such polymers. In some implementations, the outer housing 205-b may be protective as well as decorative.

The inner housing 205-a may be configured to interface with the user's finger. The inner housing 205-a may be formed from a polymer (e.g., a medical grade polymer) or other material. In some implementations, the inner housing 205-a may be transparent. For example, the inner housing 205-a may be transparent to light emitted by the PPG light emitting diodes (LEDs). In some implementations, the inner housing 205-a component may be molded onto the outer housing 205-b. For example, the inner housing 205-a may include a polymer that is molded (e.g., injection molded) to fit into an outer housing 205-b metallic shell.

The ring 104 may include one or more substrates (not illustrated). The device electronics and battery 210 may be included on the one or more substrates. For example, the device electronics and battery 210 may be mounted on one or more substrates. Example substrates may include one or more printed circuit boards (PCBs), such as flexible PCB (e.g., polyimide). In some implementations, the electronics/battery 210 may include surface mounted devices (e.g., surface-mount technology (SMT) devices) on a flexible PCB. In some implementations, the one or more substrates (e.g., one or more flexible PCBs) may include electrical traces that provide electrical communication between device electronics. The electrical traces may also connect the battery 210 to the device electronics.

The device electronics, battery 210, and substrates may be arranged in the ring 104 in a variety of ways. In some implementations, one substrate that includes device electronics may be mounted along the bottom of the ring 104 (e.g., the bottom half), such that the sensors (e.g., PPG system 235, temperature sensors 240, motion sensors 245, and other sensors) interface with the underside of the user's finger. In these implementations, the battery 210 may be included along the top portion of the ring 104 (e.g., on another substrate).

The various components/modules of the ring 104 represent functionality (e.g., circuits and other components) that may be included in the ring 104. Modules may include any discrete and/or integrated electronic circuit components that implement analog and/or digital circuits capable of producing the functions attributed to the modules herein. For example, the modules may include analog circuits (e.g., amplification circuits, filtering circuits, analog/digital conversion circuits, and/or other signal conditioning circuits). The modules may also include digital circuits (e.g., combinational or sequential logic circuits, memory circuits etc.).

The memory 215 (memory module) of the ring 104 may include any volatile, non-volatile, magnetic, or electrical media, such as a random access memory (RAM), read-only memory (ROM), non-volatile RAM (NVRAM), electrically-erasable programmable ROM (EEPROM), flash memory, or any other memory device. The memory 215 may store any of the data described herein. For example, the memory 215 may be configured to store data (e.g., motion data, temperature data, PPG data) collected by the respective sensors and PPG system 235. Furthermore, memory 215 may include instructions that, when executed by one or more processing circuits, cause the modules to perform various functions attributed to the modules herein. The device electronics of the ring 104 described herein are only example device electronics. As such, the types of electronic components used to implement the device electronics may vary based on design considerations.

The functions attributed to the modules of the ring 104 described herein may be embodied as one or more processors, hardware, firmware, software, or any combination thereof. Depiction of different features as modules is intended to highlight different functional aspects and does not necessarily imply that such modules must be realized by separate hardware/software components. Rather, functionality associated with one or more modules may be performed by separate hardware/software components or integrated within common hardware/software components.

The processing module 230-a of the ring 104 may include one or more processors (e.g., processing units), microcontrollers, digital signal processors, systems on a chip (SOCs), and/or other processing devices. The processing module 230-a communicates with the modules included in the ring 104. For example, the processing module 230-a may transmit/receive data to/from the modules and other components of the ring 104, such as the sensors. As described herein, the modules may be implemented by various circuit components. Accordingly, the modules may also be referred to as circuits (e.g., a communication circuit and power circuit).

The processing module 230-a may communicate with the memory 215. The memory 215 may include computer-readable instructions that, when executed by the processing module 230-a, cause the processing module 230-a to perform the various functions attributed to the processing module 230-a herein. In some implementations, the processing module 230-a (e.g., a microcontroller) may include additional features associated with other modules, such as communication functionality provided by the communication module 220-a (e.g., an integrated Bluetooth Low Energy transceiver) and/or additional onboard memory 215.

The communication module 220-a may include circuits that provide wireless and/or wired communication with the user device 106 (e.g., communication module 220-b of the user device 106) or a communication module 220 associated with a charger of the ring 104. In some implementations, the communication modules 220-a, 220-b, or the communication module 220 of the charger may include wireless communication circuits, such as Bluetooth circuits, infrared light emitters and detectors, and/or Wi-Fi circuits. In some implementations, the communication modules 220-a, 220-b, or the communication module 220 of the charger can include wired communication circuits, such as Universal Serial Bus (USB) communication circuits. Using the communication module 220-a, the ring 104 and the user device 106 (e.g., and the charger) may be configured to communicate with each other. The processing module 230-a of the ring may be configured to transmit/receive data to/from the user device 106 or the charger via the communication module 220-a. Example data may include, but is not limited to, motion data, temperature data, pulse waveforms, heart rate data, HRV data, PPG data, and status updates (e.g., charging status, battery charge level, and/or ring 104 configuration settings). The processing module 230-a of the ring may also be configured to receive updates (e.g., software/firmware updates) and data from the user device 106.

The ring 104 may include a battery 210 (e.g., a rechargeable battery 210). An example battery 210 may include a Lithium-Ion or Lithium-Polymer type battery 210, although a variety of battery 210 options are possible. The battery 210 may be wirelessly charged. In some implementations, the ring 104 may include a power source other than the battery 210, such as a capacitor. The power source (e.g., battery 210 or capacitor) may have a curved geometry that matches the curve of the ring 104. In some aspects, a charger or other power source may include additional sensors that may be used to collect data in addition to, or that supplements, data collected by the ring 104 itself. Moreover, a charger or other power source for the ring 104 may function as a user device 106, in which case the charger or other power source for the ring 104 may be configured to receive data from the ring 104, store and/or process data received from the ring 104, and communicate data between the ring 104 and the servers 110.

In some aspects, the ring 104 includes a power module 225 that may control charging of the battery 210. For example, the power module 225 may interface with an external wireless charger that charges the battery 210 when interfaced with the ring 104. The charger may include a datum structure that mates with a ring 104 datum structure to create a specified orientation with the ring 104 during charging. The power module 225 may also regulate voltage(s) of the device electronics, regulate power output to the device electronics, and monitor the state of charge of the battery 210. In some implementations, the battery 210 may include a protection circuit module (PCM) that protects the battery 210 from high current discharge, over voltage during charging, and under voltage during discharge. The power module 225 may also include electro-static discharge (ESD) protection.

The one or more temperature sensors 240 may be electrically coupled to the processing module 230-a. The temperature sensor 240 may be configured to generate a temperature signal (e.g., temperature data) that indicates a temperature read or sensed by the temperature sensor 240. The processing module 230-a may determine a temperature of the user in the location of the temperature sensor 240. For example, in the ring 104, temperature data generated by the temperature sensor 240 may indicate a temperature of a user at the user's finger (e.g., skin temperature). In some implementations, the temperature sensor 240 may contact the user's skin. In other implementations, a portion of the housing 205 (e.g., the inner housing 205-a) may form a barrier (e.g., a thin, thermally conductive barrier) between the temperature sensor 240 and the user's skin. In some implementations, portions of the ring 104 configured to contact the user's finger may have thermally conductive portions and thermally insulative portions. The thermally conductive portions may conduct heat from the user's finger to the temperature sensors 240. The thermally insulative portions may insulate portions of the ring 104 (e.g., the temperature sensor 240) from ambient temperature.

In some implementations, the temperature sensor 240 may generate a digital signal (e.g., temperature data) that the processing module 230-a may use to determine the temperature. As another example, in cases where the temperature sensor 240 includes a passive sensor, the processing module 230-a (or a temperature sensor 240 module) may measure a current/voltage generated by the temperature sensor 240 and determine the temperature based on the measured current/voltage. Example temperature sensors 240 may include a thermistor, such as a negative temperature coefficient (NTC) thermistor, or other types of sensors including resistors, transistors, diodes, and/or other electrical/electronic components.

The processing module 230-a may sample the user's temperature over time. For example, the processing module 230-a may sample the user's temperature according to a sampling rate. An example sampling rate may include one sample per second, although the processing module 230-a may be configured to sample the temperature signal at other sampling rates that are higher or lower than one sample per second. In some implementations, the processing module 230-a may sample the user's temperature continuously throughout the day and night. Sampling at a sufficient rate (e.g., one sample per second) throughout the day may provide sufficient temperature data for analysis described herein.

The processing module 230-a may store the sampled temperature data in memory 215. In some implementations, the processing module 230-a may process the sampled temperature data. For example, the processing module 230-a may determine average temperature values over a period of time. In one example, the processing module 230-a may determine an average temperature value each minute by summing all temperature values collected over the minute and dividing by the number of samples over the minute. In a specific example where the temperature is sampled at one sample per second, the average temperature may be a sum of all sampled temperatures for one minute divided by sixty seconds. The memory 215 may store the average temperature values over time. In some implementations, the memory 215 may store average temperatures (e.g., one per minute) instead of sampled temperatures in order to conserve memory 215.

The sampling rate, which may be stored in memory 215, may be configurable. In some implementations, the sampling rate may be the same throughout the day and night. In other implementations, the sampling rate may be changed throughout the day/night. In some implementations, the ring 104 may filter/reject temperature readings, such as large spikes in temperature that are not indicative of physiological changes (e.g., a temperature spike from a hot shower). In some implementations, the ring 104 may filter/reject temperature readings that may not be reliable due to other factors, such as excessive motion during exercise (e.g., as indicated by a motion sensor 245).

The ring 104 (e.g., communication module) may transmit the sampled and/or average temperature data to the user device 106 for storage and/or further processing. The user device 106 may transfer the sampled and/or average temperature data to the server 110 for storage and/or further processing.

Although the ring 104 is illustrated as including a single temperature sensor 240, the ring 104 may include multiple temperature sensors 240 in one or more locations, such as arranged along the inner housing 205-a near the user's finger. In some implementations, the temperature sensors 240 may be stand-alone temperature sensors 240. Additionally, or alternatively, one or more temperature sensors 240 may be included with other components (e.g., packaged with other components), such as with the accelerometer and/or processor.

The processing module 230-a may acquire and process data from multiple temperature sensors 240 in a similar manner described with respect to a single temperature sensor 240. For example, the processing module 230 may individually sample, average, and store temperature data from each of the multiple temperature sensors 240. In other examples, the processing module 230-a may sample the sensors at different rates and average/store different values for the different sensors. In some implementations, the processing module 230-a may be configured to determine a single temperature based on the average of two or more temperatures determined by two or more temperature sensors 240 in different locations on the finger.

The temperature sensors 240 on the ring 104 may acquire distal temperatures at the user's finger (e.g., any finger). For example, one or more temperature sensors 240 on the ring 104 may acquire a user's temperature from the underside of a finger or at a different location on the finger. In some implementations, the ring 104 may continuously acquire distal temperature (e.g., at a sampling rate). Although distal temperature measured by a ring 104 at the finger is described herein, other devices may measure temperature at the same/different locations. In some cases, the distal temperature measured at a user's finger may differ from the temperature measured at a user's wrist or other external body location. Additionally, the distal temperature measured at a user's finger (e.g., a “shell” temperature) may differ from the user's core temperature. As such, the ring 104 may provide a useful temperature signal that may not be acquired at other internal/external locations of the body. In some cases, continuous temperature measurement at the finger may capture temperature fluctuations (e.g., small or large fluctuations) that may not be evident in core temperature. For example, continuous temperature measurement at the finger may capture minute-to-minute or hour-to-hour temperature fluctuations that provide additional insight that may not be provided by other temperature measurements elsewhere in the body.

The ring 104 may include a PPG system 235. The PPG system 235 may include one or more optical transmitters that transmit light. The PPG system 235 may also include one or more optical receivers that receive light transmitted by the one or more optical transmitters. An optical receiver may generate a signal (hereinafter “PPG” signal) that indicates an amount of light received by the optical receiver. The optical transmitters may illuminate a region of the user's finger. The PPG signal generated by the PPG system 235 may indicate the perfusion of blood in the illuminated region. For example, the PPG signal may indicate blood volume changes in the illuminated region caused by a user's pulse pressure. The processing module 230-a may sample the PPG signal and determine a user's pulse waveform based on the PPG signal. The processing module 230-a may determine a variety of physiological parameters based on the user's pulse waveform, such as a user's respiratory rate, heart rate, HRV, oxygen saturation, and other circulatory parameters.

In some implementations, the PPG system 235 may be configured as a reflective PPG system 235 where the optical receiver(s) receive transmitted light that is reflected through the region of the user's finger. In some implementations, the PPG system 235 may be configured as a transmissive PPG system 235 where the optical transmitter(s) and optical receiver(s) are arranged opposite to one another, such that light is transmitted directly through a portion of the user's finger to the optical receiver(s).

The number and ratio of transmitters and receivers included in the PPG system 235 may vary. Example optical transmitters may include light-emitting diodes (LEDs). The optical transmitters may transmit light in the infrared spectrum and/or other spectrums. Example optical receivers may include, but are not limited to, photosensors, phototransistors, and photodiodes. The optical receivers may be configured to generate PPG signals in response to the wavelengths received from the optical transmitters. The location of the transmitters and receivers may vary. Additionally, a single device may include reflective and/or transmissive PPG systems 235.

The PPG system 235 illustrated in FIG. 2 may include a reflective PPG system 235 in some implementations. In these implementations, the PPG system 235 may include a centrally located optical receiver (e.g., at the bottom of the ring 104) and two optical transmitters located on each side of the optical receiver. In this implementation, the PPG system 235 (e.g., optical receiver) may generate the PPG signal based on light received from one or both of the optical transmitters. In other implementations, other placements, combinations, and/or configurations of one or more optical transmitters and/or optical receivers are contemplated.

The processing module 230-a may control one or both of the optical transmitters to transmit light while sampling the PPG signal generated by the optical receiver. In some implementations, the processing module 230-a may cause the optical transmitter with the stronger received signal to transmit light while sampling the PPG signal generated by the optical receiver. For example, the selected optical transmitter may continuously emit light while the PPG signal is sampled at a sampling rate (e.g., 250 Hz).

Sampling the PPG signal generated by the PPG system 235 may result in a pulse waveform that may be referred to as a “PPG.” The pulse waveform may indicate blood pressure vs time for multiple cardiac cycles. The pulse waveform may include peaks that indicate cardiac cycles. Additionally, the pulse waveform may include respiratory induced variations that may be used to determine respiration rate. The processing module 230-a may store the pulse waveform in memory 215 in some implementations. The processing module 230-a may process the pulse waveform as it is generated and/or from memory 215 to determine user physiological parameters described herein.

The processing module 230-a may determine the user's heart rate based on the pulse waveform. For example, the processing module 230-a may determine heart rate (e.g., in beats per minute) based on the time between peaks in the pulse waveform. The time between peaks may be referred to as an interbeat interval (IBI). The processing module 230-a may store the determined heart rate values and IBI values in memory 215.

The processing module 230-a may determine HRV over time. For example, the processing module 230-a may determine HRV based on the variation in the IBIs. The processing module 230-a may store the HRV values over time in the memory 215. Moreover, the processing module 230-a may determine the user's respiratory rate over time. For example, the processing module 230-a may determine respiratory rate based on frequency modulation, amplitude modulation, or baseline modulation of the user's IBI values over a period of time. Respiratory rate may be calculated in breaths per minute or as another breathing rate (e.g., breaths per 30 seconds). The processing module 230-a may store user respiratory rate values over time in the memory 215.

The ring 104 may include one or more motion sensors 245, such as one or more accelerometers (e.g., 6-D accelerometers) and/or one or more gyroscopes (gyros). The motion sensors 245 may generate motion signals that indicate motion of the sensors. For example, the ring 104 may include one or more accelerometers that generate acceleration signals that indicate acceleration of the accelerometers. As another example, the ring 104 may include one or more gyro sensors that generate gyro signals that indicate angular motion (e.g., angular velocity) and/or changes in orientation. The motion sensors 245 may be included in one or more sensor packages. An example accelerometer/gyro sensor is a Bosch BM1160 inertial micro electro-mechanical system (MEMS) sensor that may measure angular rates and accelerations in three perpendicular axes.

The processing module 230-a may sample the motion signals at a sampling rate (e.g., 50 Hz) and determine the motion of the ring 104 based on the sampled motion signals. For example, the processing module 230-a may sample acceleration signals to determine acceleration of the ring 104. As another example, the processing module 230-a may sample a gyro signal to determine angular motion. In some implementations, the processing module 230-a may store motion data in memory 215. Motion data may include sampled motion data as well as motion data that is calculated based on the sampled motion signals (e.g., acceleration and angular values).

The ring 104 may store a variety of data described herein. For example, the ring 104 may store temperature data, such as raw sampled temperature data and calculated temperature data (e.g., average temperatures). As another example, the ring 104 may store PPG signal data, such as pulse waveforms and data calculated based on the pulse waveforms (e.g., heart rate values, IBI values, HRV values, and respiratory rate values). The ring 104 may also store motion data, such as sampled motion data that indicates linear and angular motion.

The ring 104, or other computing device, may calculate and store additional values based on the sampled/calculated physiological data. For example, the processing module 230 may calculate and store various metrics, such as sleep metrics (e.g., a Sleep Score), activity metrics, and readiness metrics. In some implementations, additional values/metrics may be referred to as “derived values.” The ring 104, or other computing/wearable device, may calculate a variety of values/metrics with respect to motion. Example derived values for motion data may include, but are not limited to, motion count values, regularity values, intensity values, metabolic equivalence of task values (METs), and orientation values. Motion counts, regularity values, intensity values, and METs may indicate an amount of user motion (e.g., velocity/acceleration) over time. Orientation values may indicate how the ring 104 is oriented on the user's finger and if the ring 104 is worn on the left hand or right hand.

In some implementations, motion counts and regularity values may be determined by counting a number of acceleration peaks within one or more periods of time (e.g., one or more 30 second to 1 minute periods). Intensity values may indicate a number of movements and the associated intensity (e.g., acceleration values) of the movements. The intensity values may be categorized as low, medium, and high, depending on associated threshold acceleration values. METs may be determined based on the intensity of movements during a period of time (e.g., 30 seconds), the regularity/irregularity of the movements, and the number of movements associated with the different intensities.

In some implementations, the processing module 230-a may compress the data stored in memory 215. For example, the processing module 230-a may delete sampled data after making calculations based on the sampled data. As another example, the processing module 230-a may average data over longer periods of time in order to reduce the number of stored values. In a specific example, if average temperatures for a user over one minute are stored in memory 215, the processing module 230-a may calculate average temperatures over a five minute time period for storage, and then subsequently erase the one minute average temperature data. The processing module 230-a may compress data based on a variety of factors, such as the total amount of used/available memory 215 and/or an elapsed time since the ring 104 last transmitted the data to the user device 106.

Although a user's physiological parameters may be measured by sensors included on a ring 104, other devices may measure a user's physiological parameters. For example, although a user's temperature may be measured by a temperature sensor 240 included in a ring 104, other devices may measure a user's temperature. In some examples, other wearable devices (e.g., wrist devices) may include sensors that measure user physiological parameters. Additionally, medical devices, such as external medical devices (e.g., wearable medical devices) and/or implantable medical devices, may measure a user's physiological parameters. One or more sensors on any type of computing device may be used to implement the techniques described herein.

The physiological measurements may be taken continuously throughout the day and/or night. In some implementations, the physiological measurements may be taken during portions of the day and/or portions of the night. In some implementations, the physiological measurements may be taken in response to determining that the user is in a specific state, such as an active state, resting state, and/or a sleeping state. For example, the ring 104 can make physiological measurements in a resting/sleep state in order to acquire cleaner physiological signals. In one example, the ring 104 or other device/system may detect when a user is resting and/or sleeping and acquire physiological parameters (e.g., temperature) for that detected state. The devices/systems may use the resting/sleep physiological data and/or other data when the user is in other states in order to implement the techniques of the present disclosure.

In some implementations, as described previously herein, the ring 104 may be configured to collect, store, and/or process data, and may transfer any of the data described herein to the user device 106 for storage and/or processing. In some aspects, the user device 106 includes a wearable application 250, an operating system (OS), a web browser application (e.g., web browser 280), one or more additional applications, and a GUI 275. The user device 106 may further include other modules and components, including sensors, audio devices, haptic feedback devices, and the like. The wearable application 250 may include an example of an application (e.g., “app”) that may be installed on the user device 106. The wearable application 250 may be configured to acquire data from the ring 104, store the acquired data, and process the acquired data as described herein. For example, the wearable application 250 may include a user interface (UI) module 255, an acquisition module 260, a processing module 230-b, a communication module 220-b, and a storage module (e.g., database 265) configured to store application data.

In some cases, the wearable device 104 and the user device 106 may be included within (or make up) the same device. For example, in some cases, the wearable device 104 may be configured to execute the wearable application 250, and may be configured to display data via the GUI 275.

The various data processing operations described herein may be performed by the ring 104, the user device 106, the servers 110, or any combination thereof. For example, in some cases, data collected by the ring 104 may be pre-processed and transmitted to the user device 106. In this example, the user device 106 may perform some data processing operations on the received data, may transmit the data to the servers 110 for data processing, or both. For instance, in some cases, the user device 106 may perform processing operations that require relatively low processing power and/or operations that require a relatively low latency, whereas the user device 106 may transmit the data to the servers 110 for processing operations that require relatively high processing power and/or operations that may allow relatively higher latency.

In some aspects, the ring 104, user device 106, and server 110 of the system 200 may be configured to evaluate sleep patterns for a user. In particular, the respective components of the system 200 may be used to collect data from a user via the ring 104, and generate one or more scores (e.g., Sleep Score, Readiness Score) for the user based on the collected data. For example, as noted previously herein, the ring 104 of the system 200 may be worn by a user to collect data from the user, including temperature, heart rate, HRV, and the like. Data collected by the ring 104 may be used to determine when the user is asleep in order to evaluate the user's sleep for a given “sleep day.” In some aspects, scores may be calculated for the user for each respective sleep day, such that a first sleep day is associated with a first set of scores, and a second sleep day is associated with a second set of scores. Scores may be calculated for each respective sleep day based on data collected by the ring 104 during the respective sleep day. Scores may include, but are not limited to, Sleep Scores, Readiness Scores, and the like.

In some cases, “sleep days” may align with the traditional calendar days, such that a given sleep day runs from midnight to midnight of the respective calendar day. In other cases, sleep days may be offset relative to calendar days. For example, sleep days may run from 6:00 pm (18:00) of a calendar day until 6:00 pm (18:00) of the subsequent calendar day. In this example, 6:00 pm may serve as a “cut-off time,” where data collected from the user before 6:00 pm is counted for the current sleep day, and data collected from the user after 6:00 pm is counted for the subsequent sleep day. Due to the fact that most individuals sleep the most at night, offsetting sleep days relative to calendar days may enable the system 200 to evaluate sleep patterns for users in such a manner that is consistent with their sleep schedules. In some cases, users may be able to selectively adjust (e.g., via the GUI) a timing of sleep days relative to calendar days so that the sleep days are aligned with the duration of time that the respective users typically sleep.

In some implementations, each overall score for a user for each respective day (e.g., Sleep Score, Readiness Score) may be determined/calculated based on one or more “contributors,” “factors,” or “contributing factors.” For example, a user's overall Sleep Score may be calculated based on a set of contributors, including: total sleep, efficiency, restfulness, REM sleep, deep sleep, latency, timing, or any combination thereof. The Sleep Score may include any quantity of contributors. The “total sleep” contributor may refer to the sum of all sleep periods of the sleep day. The “efficiency” contributor may reflect the percentage of time spent asleep compared to time spent awake while in bed, and may be calculated using the efficiency average of long sleep periods (e.g., primary sleep period) of the sleep day, weighted by a duration of each sleep period. The “restfulness” contributor may indicate how restful the user's sleep is, and may be calculated using the average of all sleep periods of the sleep day, weighted by a duration of each period. The restfulness contributor may be based on a “wake up count” (e.g., sum of all the wake-ups (when user wakes up) detected during different sleep periods), excessive movement, and a “got up count” (e.g., sum of all the got-ups (when user gets out of bed) detected during the different sleep periods).

The “REM sleep” contributor may refer to a sum total of REM sleep durations across all sleep periods of the sleep day including REM sleep. Similarly, the “deep sleep” contributor may refer to a sum total of deep sleep durations across all sleep periods of the sleep day including deep sleep. The “latency” contributor may signify how long (e.g., average, median, longest) the user takes to go to sleep, and may be calculated using the average of long sleep periods throughout the sleep day, weighted by a duration of each period and the number of such periods (e.g., consolidation of a given sleep stage or sleep stages may be its own contributor or weight other contributors). Lastly, the “timing” contributor may refer to a relative timing of sleep periods within the sleep day and/or calendar day, and may be calculated using the average of all sleep periods of the sleep day, weighted by a duration of each period.

By way of another example, a user's overall Readiness Score may be calculated based on a set of contributors, including: sleep, sleep balance, heart rate, HRV balance, recovery index, temperature, activity, activity balance, or any combination thereof. The Readiness Score may include any quantity of contributors. The “sleep” contributor may refer to the combined Sleep Score of all sleep periods within the sleep day. The “sleep balance” contributor may refer to a cumulative duration of all sleep periods within the sleep day. In particular, sleep balance may indicate to a user whether the sleep that the user has been getting over some duration of time (e.g., the past two weeks) is in balance with the user's needs. Typically, adults need 7-9 hours of sleep a night to stay healthy, alert, and to perform at their best both mentally and physically. However, it is normal to have an occasional night of bad sleep, so the sleep balance contributor takes into account long-term sleep patterns to determine whether each user's sleep needs are being met. The “resting heart rate” contributor may indicate a lowest heart rate from the longest sleep period of the sleep day (e.g., primary sleep period) and/or the lowest heart rate from naps occurring after the primary sleep period.

Continuing with reference to the “contributors” (e.g., factors, contributing factors) of the Readiness Score, the “HRV balance” contributor may indicate a highest HRV average from the primary sleep period and the naps happening after the primary sleep period. The HRV balance contributor may help users keep track of their recovery status by comparing their HRV trend over a first time period (e.g., two weeks) to an average HRV over some second, longer time period (e.g., three months). The “recovery index” contributor may be calculated based on the longest sleep period. Recovery index measures how long it takes for a user's resting heart rate to stabilize during the night. A sign of a very good recovery is that the user's resting heart rate stabilizes during the first half of the night, at least six hours before the user wakes up, leaving the body time to recover for the next day. The “body temperature” contributor may be calculated based on the longest sleep period (e.g., primary sleep period) or based on a nap happening after the longest sleep period if the user's highest temperature during the nap is at least 0.5° C. higher than the highest temperature during the longest period. In some aspects, the ring may measure a user's body temperature while the user is asleep, and the system 200 may display the user's average temperature relative to the user's baseline temperature. If a user's body temperature is outside of their normal range (e.g., clearly above or below 0.0), the body temperature contributor may be highlighted (e.g., go to a “Pay attention” state) or otherwise generate an alert for the user.

In some aspects, the system 200 may support techniques for a charger for a wearable ring device 104 to perform a fingerprint scan to increase security of sensitive data (e.g., health data, NFC data) stored in the memory 215 of the wearable ring device 104. In other words, a charger device may include a fingerprint reader, where the fingerprint reader is used to authenticate an identify of the user before physiological data collected via the wearable ring device 104 is able to be transferred to another device, such as the charger device, the user device 106, servers 110, etc.

For example, a user may protect the sensitive data by preventing the data from being uploaded (e.g., from the wearable ring device 104 to an external device such as the charger or a smart device 106) until a fingerprint scan is performed. A fingerprint scanner of the charger may include one or more of a capacitance reader, an optical sensor (e.g., a camera), or an ultrasonic sensor to sense data associated with the fingerprint of the user. In some examples, the wearable ring device 104 may store fingerprint data associated with the user to allow the user to scan the wearable ring device 104 in lieu of scanning a physical fingerprint.

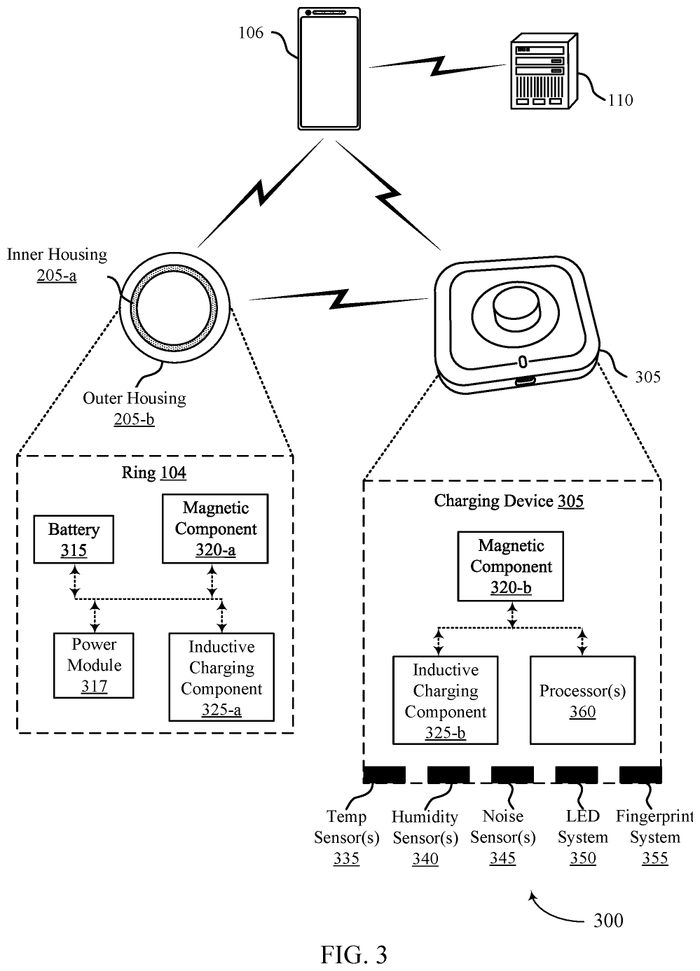

FIG. 3 shows an example of a system 300 that supports a wearable device charger with a fingerprint reader in accordance with aspects of the present disclosure. The system 300 may implement, or be implemented by system 100, system 200, or both. In particular, system 300 illustrates an example of a ring 104 (e.g., wearable device 104), as described with reference to FIGS. 1 and 2, and a charging device 305.

In some aspects, the ring 104 may be configured to be worn around a user's finger and may measure one or more user physiological parameters when worn around the user's finger. Example measurements and determinations may include, but are not limited to, user skin temperature, pulse waveforms, respiratory rate, heart rate, HRV, blood oxygen levels, and the like.

The system 300 further includes a charging device 305. The ring 104 may be in wireless and/or wired communication with a user device 106 and/or server 110. Similarly, the charging device 305 may be in wireless and/or wired communication with a user device 106, the ring 104, a server 110, or any combination thereof. In some implementations, the charging device 305 may send or receive measured and processed data (e.g., temperature data, humidity data, noise data, physiological data, fingerprint data, and the like) to or from the user device 106, the ring 104, or both. Various data processing procedures described herein may be performed by any of the components of system 300, including the ring 104, charging device 305, user device 106, server 110, or any combination thereof. In this regard, the charging device 305 (e.g., charger device) may include one or more processors 360. As will be described in further detail herein, the one or more processors 360 of the charging device 305 may be configured to evaluate fingerprint scans received via the fingerprint system 355 in order to authorize the transfer of data to/from the ring 104.

Data may be collected, stored, and analyzed via one or more components of the system 300. Moreover, in some implementations, the charging device 305 may be configured to collect and analyze data, including ambient temperature data, noise data, fingerprint data, and the like, or to receive data collected via the ring 104. The user device 106 may receive the data collected via the ring 104 and determine a correlation between sleep data from the ring 104 and the measured and processed data from the charging device 305 (e.g., if the air temperature is relatively high, a user of the ring 104 may wake up throughout a sleep duration). In other words, data collected via the charging device 305 (e.g., ambient air temperature data, noise data) may be used to further analyze physiological data collected via the ring 104.

The ring 104 may include an inner housing 205-a and an outer housing 205-b, as described with reference to FIG. 2. In some aspects, the housing 205 of the ring 104 may store or otherwise include various components of the ring 104 including, but not limited to, device electronics (e.g., a power module 317, which may be an example of a power module 225 as described with reference to FIG. 2), a power source (e.g., battery 315, which may be an example of a battery 210 as described with reference to FIG. 2, and/or capacitor), one or more substrates (e.g., printable circuit boards) that interconnect the device electronics and/or power source, store data, and the like. In some examples, the housing 205 may also store a magnetic component 320-a (e.g., ferrite tape, other charging magnet, a transmitter coil, a rare earth magnet, or the like) and an inductive charging component 325 (e.g., inductive charging component 325-a).

The ring 104 shown and described with reference to FIGS. 2 and 3 is provided solely for illustrative purposes. As such, the ring 104 may include additional or alternative components as those illustrated in FIGS. 2 and 3. Other rings 104 that provide functionality described herein may be fabricated. For example, rings 104 with fewer components (e.g., sensors) may be fabricated. In a specific example, a ring 104 may include ferrite tape, which may act as both the magnetic component 320-a and the inductive charging component 325-a. In other cases, the ring 104 may include a dedicated charger magnet. For example, the ring 104 may include a metal plate and/or ferrite tape disposed proximate to a charger magnet.

The ring 104 may be in electronic communication with the charging device 305. The charging device 305 may charge the battery 312 of the ring 104. The charging device 305 may include a base that includes a support structure (e.g., charging post), which may store or otherwise include various components of the charging device 305. In some aspects, the support (e.g., charging post) of the charging device 305 may store or otherwise include various components of the charging device 305 including, but not limited to, a magnetic component 320-b (e.g., ferrite tape, a transmitter coil, a rare earth magnet, or the like), an inductive charging component 325-b, or a fingerprint reader device (e.g., an optical-based fingerprint reader device, a capacitance-based fingerprint reader device, or an ultrasonic-based fingerprint reader device) associated with a fingerprint system 355.

In some cases, the magnetic component 320-b of the charging device 305 may include multiple magnets arranged according to a pattern based on a polarity of each magnet. For example, each magnet may have a polarity facing outward towards the surface of the charging device 305 to attract the magnetic component 320-a of the ring 104 with an opposite polarity. The charging component 325-b of the charging device 305 (e.g., transmitter coil, ferrite tape) may couple with charging component 325-a of the ring 104 (e.g., receiver coil, ferrite tape) to charge the battery 312 of the ring 104. In some examples, the charging component 325-a and the charging component 325-b may support charging of the battery 312 via direct electrical coupling (e.g., of contacts at the surface of the charging device 305 and the ring 104). Additionally, or alternatively, the charging component 325-a and the charging component 325-b may be examples of inductive charging components, which may support charging of the battery 312 via indirect electrical coupling. Inductive charging may also be referred to as wireless charging and may allow power to transfer from the charging device 305 to the battery 312 of the ring 104 using electromagnetic induction.

In some examples, the charging device 305 may include one or more temperature sensors 335. The temperature sensors 335 may measure an average air temperature over a duration, may continuously measure air temperature, or both. Similarly, the charging device 305 may include one or more humidity sensors 340. The humidity sensors 340 may measure an average humidity level over a duration, may continuously measure humidity level, or both. The humidity sensors 340 may measure the humidity as a percentage (e.g., 35% humidity). The charging device 305 may include one or more noise sensors 345. The noise sensors 345 may measure a noise level (e.g., in decibels) averaged over a duration, continuously, or both. The charging device 305 may store the humidity measurements, the temperature measurements, the noise measurements, or a combination thereof.

The charging device 305 may include any type of sensor known in the art and may be configured to collect any type of data which may be used to provide insight into a user's environment and overall health. For example, the charging device 305 may include light sensors configured to measure an amount of light and/or type of light (e.g., wavelength). In such cases, the system 300 may be configured to determine whether light levels and/or which types of light may result positively or negatively affect a user's sleep and health (e.g., determine if blue light is more disruptive to a user's sleep as compared to red light). By way of another example, the charging device 305 may include air quality sensors configured to measure air quality, pollutants, allergens, and the like. Data collected via sensors of the charger base may be leveraged to determine how a user's surrounding environment may affect their physiological data, sleep, and overall health. A processing module, such as a processing module 230 as described with reference to FIG. 2, at the user device 106 or at the charging device 305 may process the data from the temperature sensors 335, the humidity sensors 340, the noise sensors 345, light sensors, air quality sensors, or a combination thereof.

In some examples, the user device 106 and/or charging device 305 may process the data from the temperature sensors 335, the humidity sensors 340, the noise sensors 345, or a combination thereof in conjunction with data from the ring 104. For example, the user device 106 may receive physiological data collected by the ring 104 which reflects one or more sleep cycles of a user and may use the data from the sensors at the charging device 305 to determine a correlation between the collected physiological data and data collected by the charging device 305. For example, the user device 106 may determine a correlation over a time interval between data collected by the charging device 305 (e.g., ambient temperature data, humidity data, noise data, and the like) with a quality of sleep for the user (as determined by collected physiological data). In other words, the system 300 may be configured to identify whether high/low temperature, humidity, and/or noise levels result in a disruption of the user's sleep cycles (e.g., low ambient temperature and humidity levels result in higher quality sleep, higher noise levels result in lower quality sleep).

Although the charging device 305 is illustrated as including temperature sensors 335, humidity sensors 340, and noise sensors 345, the charging device 305 may include any quantity and type of sensors in one or more locations. For example, the charging device 305 may also include a motion sensor, a light sensor, a proximity sensor, or the like.

In some cases, the charging device 305 may include an LED system 350. The LED system 350 may display one or more indications to a user of the ring 104. For example, the LED system 350 may display a battery level of the battery 312, a battery health/charge status (e.g., end of battery life), a time of day, connectivity issues, one or more scores of the user (e.g., a sleep score related to how well a user slept, a readiness score or level, an activity level, or the like). Additionally, or alternatively, the LED system 350 may display one or more alerts to the user (e.g., action items prompting the user to perform an action, and the like). The LED system 350 may display a battery level of the battery 312 of the ring 104 as a percentage of total battery by displaying the numbers of the percentage, by illuminating a portion of LEDs (e.g., if a battery level is at 50%, 5 of 10 LEDs may be displayed), or the like. The LEDs in the LED system 350 may be oriented in any arrangement on the charging device 305, may be any color combination (e.g., red LED, blue LED, green LED), and there may be any quantity of LEDs in the LED system 350.

In some cases, the charging device 305 may include a fingerprint system 355. The fingerprint system 355 may include a fingerprint reader device configured to scan a fingerprint of a user of the wearable ring device 104. For example, the fingerprint system 355 may verify a fingerprint scan from the user via a fingerprint reader device (e.g., an optical sensor or camera, an ultrasonic sensor, a capacitance reader) to authenticate the user and authorize transfer of data stored in a memory of the wearable ring device 104. The stored data may include physiological data collected from the user (e.g., as described with reference to FIGS. 1-2), NFC data, or any other sensitive data stored by the wearable ring device 104. The charging device 305 may verify the fingerprint scan of the user by comparing fingerprint data from the fingerprint scan with a reference fingerprint scan associated with the user. After verifying the user, the charging device 305 may transmit one or more signals to the wearable ring device 104 to initiate transfer of the data. The wearable ring device 104 may accordingly transfer the data to the smart device 106, to the charging device 305, or to an external device (e.g., via communication modules of the corresponding devices, as described with reference to FIG. 2.)

The fingerprint system 355 of the charging device 305 may include one or more additional components configured to analyze received fingerprint scans and authenticate an identity of the user. In some cases, the fingerprint system 355 may activate a fingerprint scanner only when the user is within a certain distance from the charging device 305. For example, the fingerprint system 355 may include a proximity sensor configured to determine a distance between the charging device 305, the user, and/or the wearable device 104 (e.g., based on receiving one or more signals from the wearable ring device 104). The fingerprint system 355 may include one or more sensors (e.g., motion sensors, temperature sensors, proximity sensors, capacitance sensors, optical sensors, ultrasonic sensors) configured to identify a contact on the surface of the fingerprint reader device. The fingerprint system 355 may include a communication module (e.g., a transceiver, a Bluetooth component, infrared transmitters or detectors) configured to receive one or more signals (e.g., from the wearable ring device 104 or the smart device 106) initiating the fingerprint scan or transmitting a subset of physiological data measured from the user via the wearable ring device 104. The fingerprint system 355 may initiate or further authorize the fingerprint scan based on the distance, contact, or one or more signals.

In some implementations, the charging device 305 may include a wired or wireless power source. For example, in some cases, the charging device 305 may be coupled with an electrical outlet or other power source. In other cases, the charging device 305 may include a battery or other internal power source to enable mobile charging of the ring 104. For example, in some implementations, the charging device 305 may include a battery or other internal power source such that a user may physically wear or carry the charger along with the ring 104 for mobile charging. For instance, the charging device 305 may be worn on a necklace so that a user may wear the charger while simultaneously charging the ring 104. In other cases, the charging device 305 may be coupled with the ring 104 (e.g., magnetically coupled, mechanically snapped onto) the ring 104 while the ring 104 is being worn so that the ring 104 may be charged (and continue to collect physiological data) as it is worn.

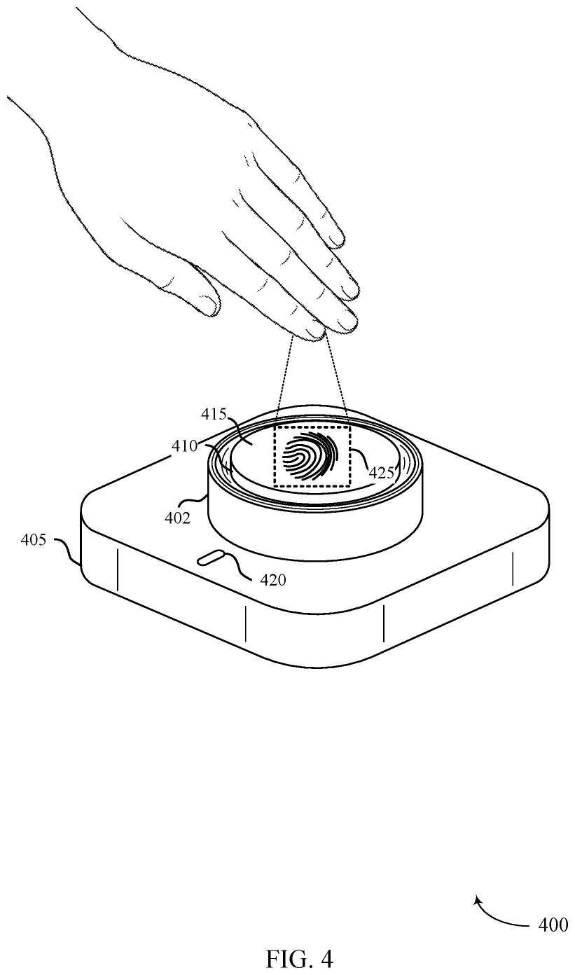

FIG. 4 shows an example of a charging diagram 400 that supports a wearable device charger with a fingerprint reader in accordance with aspects of the present disclosure. The charging diagram 400 illustrates an example of a wearable device 402 (e.g., a ring, a bracelet, or another device) and a charging device 405, as described herein with reference to FIGS. 1 through 3. Although the charging diagram 400 is illustrated with the wearable device 402 mounted onto a base (e.g., support structure) of the charging device 405, the described techniques may be used with the wearable device 402 in an unmounted state (e.g., being worn by a user of the wearable device 402).

The charging diagram 400 illustrates a potential implementation of a fingerprint reader device 415 integrated into the charging device 405 which may be configured to authenticate a fingerprint scan 425 of the user. The charging device 405 may use the fingerprint scan 425 to authenticate an identity of the user and/or authorize transfer of data stored in the wearable device 402.

In some examples, a base of the charging device 405 may include a support 410 (also referred to herein as a charging post or mounting portion), and the wearable device 402 may be configured to charge when positioned against the support 410 of the charging device 405 (e.g., surrounding a circumference of the support 410). For example, the support 410 and the wearable device 402 may have one or more charging components (e.g., inductive or contact-based charging components disposed within the support 410 and the wearable device 402, respectively), such that the wearable device 402 is configured to charge when the charging components of the wearable device 402 are within a threshold distance or are in physical contact with one of the charging components of the charging device 405 (e.g., within the support 410). In some examples, the support 410 may include one or more indentations or protrusions that are configured to interface with one or more “domes” or indentations of the wearable device 402 when the wearable device 402 is placed onto the charging device 405. In some examples, the fingerprint reader device 415 may be located on a top (e.g., distal) surface of the support 410 or in a different position on the surface of the charging device 405 or the support 410.

The charging device 405 may receive the fingerprint scan 425 via the fingerprint reader device 415. For example, the fingerprint reader device 415 may use one or more sensors (e.g., optical sensors, ultrasonic sensors, capacitance sensors) to receive data associated with the fingerprint of the user. In some examples, in cases where the fingerprint reader device 415 includes an optical sensor, the fingerprint reader device 415 may receive an image (e.g., a photograph) of the fingerprint scan 425 via a window configured to contact a finger of the user and one or more light-emitting components configured to emit light through the window (e.g., during a time interval of the fingerprint scan 425). The fingerprint reader device 415 may use an imaging device configured to capture one or more images of the finger through the window during the time interval to perform/capture the fingerprint scan 425.

In some examples, in cases where the fingerprint reader device 415 includes a capacitance sensor, the fingerprint reader device 415 may use one or more circuits (e.g., a matrix sensor) to determine a capacitance associated with “ridges” and “valleys” of the fingerprint of the user. For example, the fingerprint reader device 415 may include a scanning surface and the matrix sensor may be configured to detect changes in an electrical charge stored across the matrix sensor based on the finger of the user being in contact with the scanning surface. The fingerprint reader device 415 may accordingly detect the ridges and valleys associated with the fingerprint of the user based on capacitances associated with the detected electrical charge changes.

In some examples, in cases where the fingerprint reader device 415 includes an ultrasonic sensor, the fingerprint reader device 415 may include an ultrasonic transmitter and receiver. The fingerprint reader device 415 may detect the ridges and valleys associated with the fingerprint of the user by transmitting an ultrasonic pulse to a scanning screen in contact with the fingerprint of the user via the transmitter, and subsequently measuring a reflection of the ultrasonic pulse via the receiver. The fingerprint reader device 415 may use the fingerprint information (e.g., the scanned image or the detected ridges and valleys of the fingerprint) to generate a set of data associated with the fingerprint scan 425.

In some aspects, the charging device 405 may authenticate an identity of the user associated with the fingerprint scan 425 by performing a comparison (e.g., matching) between the fingerprint scan 425 with a reference fingerprint scan associated with the user. In other words, the user may input one or more “reference” fingerprint scans during a setup procedure, where subsequent fingerprint scans 425 are compared to the “reference” fingerprint scans in order to verify/authenticate the identity of the user.

For example, the charging device 405 may receive data associated with one or more reference fingerprint scans (e.g., including the reference fingerprint scan) associated with the user by performing one or more initial fingerprint scans 425 prior to the authorization or by receiving the reference fingerprint scan from the wearable device 402, a smart device (e.g., a smartphone), or another external device. The charging device 405 may accordingly compare the data associated with the reference fingerprint scan with the set of data associated with the fingerprint scan 425. The charging device 405 may authorize transfer of data from the wearable device 402 to another device (e.g., the charging device 405, a user device 106, servers 110, etc.) if the charging device 405 determines that the fingerprint scan 425 matches the reference fingerprint scan. That is, the charging device 405 may transmit one or more signals to the wearable device 402 that include an authorization for the wearable device 402 to transfer the sensitive data. The wearable device 402 may accordingly transmit the sensitive data (e.g., to the charging device 405, to the smart device, to an external device) in response to the authorization.

In some aspects, the charging device 405 may determine one or more trigger conditions for activating the fingerprint reader device 415 used to acquire the fingerprint scan 425. For example, the charging device 405 may activate the fingerprint reader device 415 in response to determining that the wearable device 402 is positioned on the charging device 405 (e.g., based on initiation of a charging procedure to begin charging a battery of the wearable device 402 as described herein), in response to identifying a contact on the surface of the fingerprint reader device 415 (e.g., a finger being placed onto the fingerprint reader device 415), or in response to one or more user inputs. The one or more user inputs may include, for example, the user inputting a request to initiate the fingerprint scan 420 into an application associated with a user device (e.g., the smart device). For example, the user may select an option in the application (e.g., wearable application 250) to begin acquisition of the fingerprint scan 425. The user device may accordingly transmit a signal to the charging device 405 to cause the fingerprint reader device 415 to begin the fingerprint scan 425. In some examples, the user input may include depression of a button on a surface of the charging device 405. That is, the charging device 405 may active the fingerprint reader device 415 in response to detecting that the button (or some other user input component) has been pressed (e.g., by the user). In some examples, the button may be within the support 410 (e.g., under the fingerprint reader device 415) or in a different position on the charging device 405.

In some cases, the charging device 405 may identify a trigger condition for activating the fingerprint reader device 415 based on a location of the user, such as a distance between the user (e.g., wearable device 402) and the charging device 405. For example, the charging device 405 may communicate one or more signals with the wearable device 402 during a time interval to determine (e.g., estimate) a distance between the charging device 405 and the wearable device 402. The charging device 405 may authenticate the user and/or initiate the fingerprint scan 425 based on the distance between the charging device 405 and the wearable device 402 being less than or equal to a threshold distance during the time interval. Stated differently, in some cases, the fingerprint reader device 415 may be activated (to enable scanning for the fingerprint scan 425) only if the user is within some threshold distance of the charging device 405 (e.g., the charging device 405 will only authenticate the user if the fingerprint scan 425 is received during a time that the user is close to the charger). In some examples, the threshold distance may include the wearable device 402 being in contact with the charging device 405 (e.g., mounted on the charging device 405, in a charging position).

In some cases, the authentication of the user may be based on both the fingerprint scan 425 and data collected from the user via the wearable device 402. For example, the charging device 405 may receive one or more signals from the wearable device 402 (e.g., or the smart device) indicating a subset of data (e.g., physiological data) stored by the wearable device 402. In this example, the charging device 405 may perform a second comparison the subset of data with a set of baseline physiological data associated with the user, and may authenticate the user based on the first comparison between the fingerprint scan 425 and the reference fingerprint scan, as well as the second comparison between the physiological data and the baseline physiological data for the user.

Requiring the identity of the user to be verified based on both the fingerprint scan 425 and collected physiological data may provide an additional layer of security to protect the user's sensitive data. For instance, in some cases, the wearable device 402 may be authorized to provide only HRV data to the charging device 402 in order to enable the charging device 402 to authenticate the user based on a comparison between the HRV data and the user's baseline HRV data. Subsequently, if the user's identity is authenticated, the wearable device 402 may be authorized to communicate more sensitive physiological data collected by the wearable device 402 (e.g., respiration rate data, sleeping pattern data, illness data, etc.). Stated differently, the wearable device 402 may transmit a first (limited) subset of data to the charging device 405 prior to user authentication, and may transmit a second (expanded) subset of data once the user has been authenticated (e.g., some types of physiological data may be transferred without user authentication, while other types of physiological data require user authentication before the wearable device 104 can transfer the data).

Additionally, or alternatively, the charging device 405 may generate a “fingerprint token” associated with the fingerprint scan 425 (e.g., and one or more previous or reference fingerprint scans 425). For example, the charging device 405 may compile fingerprint data associated with (e.g., indicative of) one or more reference fingerprint scans to generate a fingerprint token including the compiled fingerprint data. The charging device 405 may accordingly transmit the generated fingerprint token to the wearable device 402. In this regard, the “fingerprint token” may be indicative of (or associated with) previous fingerprint scans 425 collected from the user, and may include a “digital version” of the user's fingerprint that may be used to authenticate the user in response to future queries for fingerprint scans.

In some examples, the wearable device 402 may store the fingerprint token in memory and use the fingerprint token to authenticate the user in response to one or more fingerprint queries (e.g., from additional fingerprint reader or authentication devices). For example, the wearable device 402 may receive an instruction from the charging device 405 (or another fingerprint reader device) to output the fingerprint token in response to the one or more fingerprint queries. The user may accordingly use the wearable device 402 to authenticate the user to the additional fingerprint reader or authentication devices in lieu of a physical fingerprint scan.

Additionally, or alternatively, the charging device 405 may authenticate the fingerprint scan 425 to authorize one or more additional processes by the wearable device 402. For example, the charging device 405 may receive an indication of a pairing procedure to pair the wearable device 402 with a user device (e.g., the smart device). In this example, the charging device 405 may active the fingerprint reader device 415 and compare the fingerprint scan 425 with the reference fingerprint scan based on the indication of the pairing procedure. The charging device 405 may transmit one or more messages to the wearable device 402 indicating success of the capture and authentication of the fingerprint scan 425, and the wearable device 402 may complete the pairing process in response to the one or more messages. In this regard, the fingerprint reader device 415 may be used as part of the pairing process for associating the wearable device 402 with the user and/or pairing the wearable device 402 with the user device 106, the wearable application 250, the charging device 405, or any combination thereof.

In some examples, upon receiving a message authorizing the wearable device to transfer data, the wearable device 402 may transfer the data to the charging device 405, the smart device, or the external device via a Bluetooth connection. In some examples, the wearable device 402 may transfer the data to the charging device 405, the smart device, or the external device via infrared communications (e.g., using one or more LEDs on the wearable device 402, the charging device 405, the smart device, or the external device). For example, the wearable device 402 may transfer the data by emitting infrared light in various pulse patterns, intensities, etc. The infrared light may be received by a detector on the charging device 405, the smart device, or the external device. Such techniques may result in a more secure transfer of data as compared to a Bluetooth connection.

In some aspects, techniques described herein may be used in a clinical setting, such as by hospitals to track the progression of patients following surgery. For example, upon being discharged from the hospital following a surgery or other medical procedure, the user may be issued a wearable device 402 that is used to collect physiological data that may be used to evaluate their recovery progress. The user may wear the wearable device 402 for the following week following the surgery/medical procedure, and may return to the hospital the next week. In this example, techniques described herein may be used to protect the user's sensitive health data by verifying the identity of the user and/or verifying that data collected by the wearable device 402 was indeed collected by the user (e.g., validating that the user did not have someone else wear the wearable device 402 following the surgery).

In addition to the hospital setting described above, aspects of the present disclosure may be used to authenticate an identity of a user in other contexts, such as other communal-based contexts where users are issued a wearable device and are expected to return the wearable device after some time. Such communal-based contexts may include sports teams, military personnel, gyms, etc. In these cases, the fingerprint techniques described herein may be used as a part of easy-to-use user interface to identify the user. Upon scanning their fingerprint and authenticating the user (as described herein), data collected by the corresponding wearable device (and/or charging device) may be transferred to the correct user account corresponding to the user. For example, after completing a workout session (gym-based context) or completing some mission (military-based context), the system herein may be used to capture a fingerprint scan of the user to authenticate the user, where data collected by the ring during the workout or mission may be transferred to the user's account upon authenticating the user. In this regard, the charging devices with fingerprint scanners described herein may reduce (or replace) the need for a wearable application, and may negate the need for such users to go through a set-up process to “pair” the wearable device to their account for occasional/infrequency use of the ring. In this regard, aspects of the present disclosure may make it easier for data collected by wearables to be associated with users in cases where the wearable devices are frequently exchanged and/or swapped between different users.

In some cases, the charging device 405 may include an indicating light 420 (e.g., an LED or similar light emitting component). The indicating light 420 may display one or more indications to a user of the wearable device 402. For example, the indicating light 420 may display a battery level of the wearable device 402, a battery health/charge status (e.g., end of battery life), a time of day, one or more scores associated with the user (e.g., a sleep score, a readiness score), or connectivity issues. In other case, the indicating light 420 may be used to communicate information associated with the fingerprint reader device 415, such as to indicate an activation state of the fingerprint reader device 415, a successful/unsuccessful capture of the fingerprint scan 425, etc. Additionally, or alternatively, the indicating light 420 may display one or more alerts to the user (e.g., action items prompting the user to perform an action, and the like). The indicating light 420 may be any color combination (e.g., red LED, blue LED, green LED), and there may include any quantity of LEDs.

It should be noted that the methods described above describe possible implementations, and that the operations and the steps may be rearranged or otherwise modified and that other implementations are possible. Furthermore, aspects from two or more of the methods may be combined.

A charging device is described. The charging device may include a base configured to receive a wearable device, the wearable device configured to acquire physiological data from a user, a charging component configured to transfer power through the base to the wearable device to charge a rechargeable battery of the wearable device, a fingerprint reader device, one or more processors communicatively coupled with the charging component, the fingerprint reader device, or both, the one or more processors configured to, receive a fingerprint scan from the fingerprint reader device, authenticate the user based at least in part on matching the fingerprint scan to a reference fingerprint scan associated with the user, and transmit one or more signals to the wearable device based at least in part on authenticating the user, the one or more signals comprising an authorization for the wearable device to transfer the physiological data of the user from the wearable device to the charging device, a user device, or both.

In some examples, the charging device may be configured to determine that the wearable device may be positioned on the base based at least in part on an initiation of a charging procedure to transfer power from the charging component to the wearable device and activate the fingerprint reader device based at least in part on the wearable device being positioned on the base, wherein receiving the fingerprint scan from the fingerprint reader device may be based at least in part on activating the fingerprint reader device.

In some examples, the one or more processors may be further configured to receive one or more user inputs via the user input device, and activate the fingerprint reader device based at least in part on the one or more user inputs, wherein receiving the fingerprint scan from the fingerprint reader device may be based at least in part on activating the fingerprint reader device.

In some examples, the one or more processors may be further configured to identify a contact on a surface of the fingerprint reader device and activate the fingerprint reader device based at least in part on identifying the contact, wherein receiving the fingerprint scan from the fingerprint reader device may be based at least in part on activating the fingerprint reader device.

In some examples, the one or more processors may be further configured to receive one or more additional signals from the wearable device during the time interval and estimate a distance between the charging device and the wearable device during the time interval based at least in part on the one or more additional signals, wherein authenticating the user may be based at least in part on the distance being less than or equal to a threshold distance.

In some examples, the one or more processors may be further configured to receive a subset of the physiological data from the wearable ring device, wherein authenticating the user may be based at least in part on a first comparison between the fingerprint scan and the reference fingerprint scan, and a second comparison between the subset of physiological data and baseline physiological data associated with the user.

In some examples, the one or more processors may be further configured to receive one or more reference fingerprint scans associated with the user from the fingerprint reader device, wherein the reference fingerprint scan may be included within or may be based at least in part on the one or more reference fingerprint scans, generate a fingerprint token indicative of the one or more reference fingerprint scans, and transmit the fingerprint token to the wearable device along with an instruction for the wearable device to output the fingerprint token in response to queries received from additional fingerprint reader devices, additional authentication devices, or both, in order to authenticate the user in accordance with the one or more reference fingerprint scans.

In some examples, the one or more processors may be further configured to receive a first message from the wearable device at a first time prior to receiving the fingerprint scan, wherein the first message comprises first information associated with a first subset of physiological parameters of the physiological data, and wherein the one or more signals comprise the authorization for the wearable device to transfer second information associated with a second subset of physiological parameters of the physiological data and receive a second message from the wearable device at a second time subsequent to receiving the fingerprint scan and transmitting the one or more signals, wherein the second message comprises the second information associated with the second subset of physiological parameters of the physiological data.

In some examples, the one or more processors may be further configured to receive an indication of a pairing procedure to be performed between the wearable device and the user device, activate the fingerprint reader device based at least in part on receiving the indication of the pairing procedure, receive one or more reference fingerprint scans associated with the user from the fingerprint reader device, wherein the reference fingerprint scan may be included within or may be based at least in part on the one or more reference fingerprint scans, and transmit, to the wearable device, the user device, or both, a message indicating a successful capture of reference fingerprint scan, wherein a completion of the pairing procedure may be based at least in part on the message.

In some examples, the fingerprint reader device comprises an optical-based fingerprint reader device, a capacitance-based fingerprint reader device, or an ultrasonic-based fingerprint reader device.

In some examples, the fingerprint reader device may include a window configured to contact a finger of the user, one or more light-emitting components configured to emit light through the window during a time interval associated with the fingerprint scan, and an imaging device configured to capture one or more images of the finger of the user through the window during the time interval, wherein the fingerprint scan may be based at least in part on the one or more images.

In some examples, the fingerprint reader device may include a scanning surface and a matrix sensor associated with the scanning surface, the matrix sensor configured to detect changes in a stored charge across the matrix sensor based at least in part on a finger of the user placed on the scanning surface, wherein the fingerprint scan may be based at least in part on the changes in the stored charge across the matrix sensor.

In some examples, the wearable device comprises a wearable ring device.

In some examples, the base may include a charging post configured to receive the wearable ring device such that the wearable ring device surrounds a circumference of the charging post, wherein the charging component may be disposed at least partially within the charging post, and wherein the fingerprint reader device comprises a scanning surface positioned on a distal surface of the charging post.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A charging device, comprising:
a base configured to receive a wearable device, the wearable device configured to acquire physiological data from a user;
a charging component configured to transfer power through the base to the wearable device to charge a rechargeable battery of the wearable device;
a fingerprint reader device; and
one or more processors communicatively coupled with the charging component, the fingerprint reader device, or both, the one or more processors configured to:
receive a fingerprint scan from the fingerprint reader device;
authenticate the user based at least in part on matching the fingerprint scan to a reference fingerprint scan associated with the user; and
transmit one or more signals to the wearable device based at least in part on authenticating the user, the one or more signals comprising an authorization for the wearable device to transfer the physiological data of the user from the wearable device to the charging device, a user device, or both.

2. The charging device of claim 1, wherein the one or more processors are further configured to:
determine that the wearable device is positioned on the base based at least in part on an initiation of a charging procedure to transfer power from the charging component to the wearable device; and
activate the fingerprint reader device based at least in part on the wearable device being positioned on the base, wherein receiving the fingerprint scan from the fingerprint reader device is based at least in part on activating the fingerprint reader device.

3. The charging device of claim 1, further comprising:
a user input device, wherein the one or more processors are further configured to:
receive one or more user inputs via the user input device; and
activate the fingerprint reader device based at least in part on the one or more user inputs, wherein receiving the fingerprint scan from the fingerprint reader device is based at least in part on activating the fingerprint reader device.

4. The charging device of claim 1, wherein the one or more processors are further configured to:
identify a contact on a surface of the fingerprint reader device; and
activate the fingerprint reader device based at least in part on identifying the contact, wherein receiving the fingerprint scan from the fingerprint reader device is based at least in part on activating the fingerprint reader device.

5. The charging device of claim 1, wherein the fingerprint scan is received during a time interval, wherein the one or more processors are further configured to:
receive one or more additional signals from the wearable device during the time interval; and
estimate a distance between the charging device and the wearable device during the time interval based at least in part on the one or more additional signals, wherein authenticating the user is based at least in part on the distance being less than or equal to a threshold distance.

6. The charging device of claim 1, wherein the one or more processors are further configured to:
receive a subset of the physiological data from the wearable device, wherein authenticating the user is based at least in part on a first comparison between the fingerprint scan and the reference fingerprint scan, and a second comparison between the subset of the physiological data and baseline physiological data associated with the user.

7. The charging device of claim 1, wherein the one or more processors are further configured to:
receive one or more reference fingerprint scans associated with the user from the fingerprint reader device, wherein the reference fingerprint scan is included within or is based at least in part on the one or more reference fingerprint scans;
generate a fingerprint token indicative of the one or more reference fingerprint scans; and
transmit the fingerprint token to the wearable device along with an instruction for the wearable device to output the fingerprint token in response to queries received from additional fingerprint reader devices, additional authentication devices, or both, in order to authenticate the user in accordance with the one or more reference fingerprint scans.

8. The charging device of claim 1, wherein the one or more processors are further configured to:
receive a first message from the wearable device at a first time prior to receiving the fingerprint scan, wherein the first message comprises first information associated with a first subset of physiological parameters of the physiological data, and wherein the one or more signals comprise the authorization for the wearable device to transfer second information associated with a second subset of physiological parameters of the physiological data; and
receive a second message from the wearable device at a second time subsequent to receiving the fingerprint scan and transmitting the one or more signals, wherein the second message comprises the second information associated with the second subset of physiological parameters of the physiological data.

9. The charging device of claim 1, wherein the one or more processors are further configured to:
receive an indication of a pairing procedure to be performed between the wearable device and the user device;
activate the fingerprint reader device based at least in part on receiving the indication of the pairing procedure;
receive one or more reference fingerprint scans associated with the user from the fingerprint reader device, wherein the reference fingerprint scan is included within or is based at least in part on the one or more reference fingerprint scans; and
transmit, to the wearable device, the user device, or both, a message indicating a successful capture of reference fingerprint scan, wherein a completion of the pairing procedure is based at least in part on the message.

10. The charging device of claim 1, wherein the fingerprint reader device comprises an optical-based fingerprint reader device, a capacitance-based fingerprint reader device, or an ultrasonic-based fingerprint reader device.

11. The charging device of claim 1, wherein the fingerprint reader device comprises:
a window configured to contact a finger of the user;
one or more light-emitting components configured to emit light through the window during a time interval associated with the fingerprint scan; and
an imaging device configured to capture one or more images of the finger of the user through the window during the time interval, wherein the fingerprint scan is based at least in part on the one or more images.

12. The charging device of claim 1, wherein the fingerprint reader device comprises:
a scanning surface; and
a matrix sensor associated with the scanning surface, the matrix sensor configured to detect changes in a stored charge across the matrix sensor based at least in part on a finger of the user placed on the scanning surface, wherein the fingerprint scan is based at least in part on the changes in the stored charge across the matrix sensor.

13. The charging device of claim 1, wherein the wearable device comprises a wearable ring device.

14. The charging device of claim 13, wherein the base comprises:
a charging post configured to receive the wearable ring device such that the wearable ring device surrounds a circumference of the charging post, wherein the charging component is disposed at least partially within the charging post, and wherein the fingerprint reader device comprises a scanning surface positioned on a distal surface of the charging post.
